(19) United States
(12) Patent Application Publication
(10) Pub. No.: US 2025/0029978 A1
(43) Pub. Date: Jan. 23, 2025

(54) ELECTRODE AND LITHIUM-ION BATTERY COMPRISING THE SAME

(71) Applicant: Academia Sinica, Taipei City (TW)

(72) Inventors: Maw-Kuan WU, Taipei City (TW); Yu-Hsuan SU, Taipei City (TW); Chin-Yi CHUNG, Taipei City (TW); Yan-Reui CHEN, Taipei City (TW); Feng-Yu WU, Taipei City (TW); Po-Wei CHI, Taipei City (TW); Phillip M. WU, Taipei City (TW)

(21) Appl. No.: 18/222,627

(22) Filed: Jul. 17, 2023

(51) Int. Cl. H01M 4/131; H01M 4/133; H01M 4/1391; H01M 4/62; H01M 10/0525

(52) U.S. Cl. CPC H01M 4/131; H01M 4/133; H01M 4/1391; H01M 4/622; H01M 10/0525; H01M 2300/0008

(57) ABSTRACT

An electrode for a lithium-ion battery is provided, which comprises: a current collector; and an electrode material layer disposed on the current collector, wherein the electrode material layer comprises an anode material and a binder, the binder is pectin, its derivative or a combination thereof, and the anode material is selected from the group consisting of lithium vanadium oxide, lithium titanium oxide, lithium iron oxide, graphite, and a combination thereof. In addition, a lithium-ion battery comprising the aforesaid electrode is also provided.

### BACKGROUND OF THE INVENTION

### Field

The present invention relates to an electrode and a lithium-ion battery comprising the same. More specifically, the present invention relates to an electrode as an anode and a lithium-ion battery comprising the same.

### Description of Related Art

The demand of energy storage devices for applications in mobile device, electric vehicle, and large-scale energy storage system makes Li-ion battery (LIB) indispensable because it is compact, relatively stable, and high energy dense. Considering worldwide market growth rate and the average life of LIBs, which is about typical 5˜10 y, one immediately foresees the problems of serious price fluctuation in raw materials for LIBs productions and the environmental impacts from the disposal of spent LIBs. The development of LIBs manufacturing processes following the circular economy framework could potentially bring a sustainable solution where waste components can be reused in the manufacturing cycle.

However, there exists a critical issue in the current recycling processes. In particular, the use of the calcination processes on the current LIBs, which commonly use polyvinylidene fluoride (PVDF) as binders for electrodes, the negative electrode at least. The calcination process on PVDF is known to cause the expulsion of potentially unhealthy incineration gases, unwanted compounds such as HCN, HF, CH₄, HCHO, COF₂, SiF₄, HNCO, higher hydrocarbons, nitrogen oxides, CO, and CO₂. These byproducts are produced when electrodes are incinerated in air and must not be released to the environment.

Therefore, it is strongly desirable to find an environmentally friendly binder material to replace PVDF for LIBs.

### SUMMARY OF THE INVENTION

The present invention provides an electrode for a lithium-ion battery, which comprises: a current collector; and an electrode material layer disposed on the current collector, wherein the electrode material layer comprises an anode material and a binder, the binder is pectin, its derivative or a combination thereof, and the anode material is selected from the group consisting of lithium vanadium oxide, lithium titanium oxide, lithium iron oxide, graphite, and a combination thereof.

The present invention also provides a lithium-ion battery, which comprises: the aforesaid electrode as a first electrode; a second electrode opposite to the first electrode; a separator disposed between the first electrode and the second electrode; and an electrolyte disposed between the first electrode and the second electrode.

The current collector used in the electrode of the present invention may be the known current collector used in the art. For example, in one embodiment, the current collector is a copper foil, but the present invention is not limited thereto.

In the present invention, the anode material is selected from the group consisting of lithium vanadium oxide (LVO), lithium titanium oxide (LTO), lithium iron oxide (LFO), graphite, and a combination thereof. In one embodiment, the anode material may be LVO. In another embodiment, the anode material may be graphite.

In the present invention, the binder is pectin, its derivative or a combination thereof. In one embodiment, the binder may be pectin. In another embodiment, the binder may be Fe-doped pectin, wherein a weight ratio of pectin to iron in the Fe-doped pectin may range from 1:1 to 10:1, such as 1:1, 2:1, 3:1, 4:1, 5:1, 6:1, 7:1, 8:1, 9:1 or 10:1.

In the present invention, an amount of the binder may range from 3 wt % to 10 wt %, such as 3 wt % to 9 wt %, 3 wt % to 8 wt %, 3 wt % to 7 wt %, 4 wt % to 7 wt % or 4 wt % to 6 wt %, based on a total weight of the electrode material layer. In one embodiment of the present invention, the amount of the binder is about 5 wt % based on the total weight of the electrode material layer. However, the present invention is not limited thereto, and the amount of the binder may be adjusted according to the needs.

In the present invention, the electrode material layer may further comprise a conductive additive. The conductive additive may be any known conductive additive used in the art, such as metal particles, conductive metal oxides or carbon black (for example, conductive carbon or acetylene black), but the present invention is not limited thereto.

In the present invention, an amount of the conductive additive may range from 1 wt % to 10 wt %, such as 1 wt % to 9 wt %, 2 wt % to 9 wt %, 2 wt % to 8 wt %, 3 wt % to 8 wt %, 3 wt % to 7 wt %, 4 wt % to 7 wt % or 4 wt % to 6 wt %, based on a total weight of the electrode material layer. In one embodiment of the present invention, the amount of the conductive additive is about 5 wt % based on the total weight of the electrode material layer. However, the present invention is not limited thereto, and the amount of the conductive additive may be adjusted according to the needs.

In the present invention, pectin and/or its derivative is used as the binder of the electrode material layer, and the electrode of the present invention has both high-energy and high-power density. In addition, the electrode materials of the present invention can be regenerated with nearly 90% material recovery and 100% capability for subsequent lithiation by a simple process. Thus, the electrode of the present invention is an environmentally friendly electrode.

Furthermore, when the electrode of the present invention is used in the lithium-ion battery, an enhanced charging specific capacity at high C-rate can be observed. In addition, pseudocapacitive effect becomes dominant for Li-storage in the lithium-ion battery, and the pseudocapacitive effect become more dominant in the regenerated lithium-ion battery, by using pectin and/or its derivative as the binder of the electrode material layer in the lithium-ion battery and the regenerated lithium-ion battery.

Other novel features of the present invention will become more apparent from the following detailed description when taken in conjunction with the accompanying drawings.

### BRIEF DESCRIPTION OF DRAWINGS

FIG. 1 is a cross-sectional view of a lithium-ion battery of the present invention.

FIG. 2A to FIG. 2F are the results showing the life cycles and lithiation-delithiation profile of LVO electrode with different binders.

FIG. 3 shows SEM images for LVO-pectin and LVO-PVDF electrodes before and after 100 cycles.

FIG. 4A to FIG. 4B are FTIR spectra of LVO-pectin and LVO-PVDF electrodes.

FIG. 4C to FIG. 4D are results of Electrochemical impedance spectroscopy.

FIG. 4E are FTIR spectra of pure pectin and PVDF.

FIG. 5A and FIG. 5B are perspective views showing the interfacial formation scenarios of LVO-pectin and LVO-PVDF.

FIG. 6A and FIG. 6B are DRT color-mapped plots of Li transition path of LVO-PVDF electrode during the lithiation and delithiation.

FIG. 6C and FIG. 6D are DRT color-mapped plots of Li transition path of LVO-pectin electrode during the lithiation and delithiation.

FIG. 7A to FIG. 7D show the CV data of LVO-pectin cell.

FIG. 8A shows the SEM image of the regenerated LVO particles.

FIG. 8B shows the cycle life of the regenerated LVO-pectin electrode under current density of 0.2 A g⁻¹ with potential ranged from 0.01V to 3V.

FIG. 8C shows the corresponding charge-discharge profile of the regenerated LVO-pectin electrode.

FIG. 8D shows the CV results at different voltage scan rates, from 0.05 to 1 mV s⁻¹.

FIG. 8E shows the result of determination of the b-value using the relationship between peak current to sweep rate.

FIG. 8F shows the CV curves of regenerated LVO-pectin electrode with separation between total current and capacitive currents at a scan rate of 1 mV s⁻¹.

FIG. 8G shows the separation of contributions from capacitive and diffusion-controlled capacities at different sweep rates based on the analysis using Randles-Sevcik relation.

FIG. 9A and FIG. 9B are the results of the cycle performance of graphite with different binders.

FIG. 9C and FIG. 9D show the results of the dQ/dV analysis.

FIG. 10A and FIG. 10B respectively are the results of the cycle performance of the natural graphite electrode made with CMC/SBR binder and Pectin-Fe binder at 1 C rate.

FIG. 11A to FIG. 11C shows DRT of graphite and with different binders.

### DETAILED DESCRIPTION OF THE INVENTION

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### Preparation of Fe-Doped Pectin

FeCl₂ (with pectin:iron ratio by weight in 2:1, 4:1, and 8:1) was mixed with deionized water and then pure pectin was added in 5% mixture aqueous solution with one day stirring. After slurry was dried, the Fe-doped pectin was obtained.

### Preparation of LVO

LVO was prepared by the solution reaction method, by using certain stoichiometric amounts of V₂O₅ and LiOH as precursors and, citric acid as a chelating agent. LiOH was dissolved in deionized water then the V₂O₅ powder was slowly poured into the continuously stirred container. After fully reaction, the solution was dried in the oven at 120° C. for one night, and then heated at 500° C. for 10 hours. The XRD data of the obtained LVO (data not shown) indicates that the pristine LVO is orthorhombic with Pnm2₁ space group and lattice parameters a=6.3241 Å, b=5.4445 Å, c=4.9455 Å, respectively.

### Preparation of Lithium Half Cells

### Embodiments

The anode materials, LVO-pectin, pectin-graphite and Fe-doped pectin-graphite, were prepared as slurries for lithium half cells, respectively. Pectin or Fe-doped pectin prepared above was mixed with 5 wt % deionized (DI) water, and stirred for 1 day. The slurries (5 wt %) were then mixed with Li₃VO₄ (90 wt %) or graphite (90 wt %), and carbon blacks (Super P) (5 wt %). Mixtures were coated on copper (Cu) foils and dried at 110° C. in oven. Electrode foils are punched into circular 14 mm diameter discs for lithium half-cell assembly. The electrolyte solution was prepared by adding 1 mol·L⁻¹ of LiPF₆ in a mixture of ethylene carbonate (EC) and diethyl carbonate (DEC) having a 1:1 volume ratio. A Celgard polypropylene membrane was used as a separator. The CR2032-type coin cells were assembled in an argon-filled glove box. The electrochemical properties of the samples in CR2032-type coin cells were tested at room temperature with metallic lithium as both the counter and reference electrode.

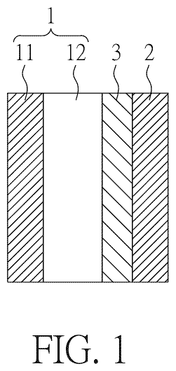

FIG. 1 is a cross-sectional view of a lithium-ion battery of the present invention. The lithium-ion battery of the present invention comprises: a first electrode 1 comprising a current collector 11 and an electrode material layer 12 disposed on the current collector 11; a second electrode 2 opposite to the first electrode 1; a separator 3 disposed between the first electrode 1 and the second electrode 2; and an electrolyte disposed between the first electrode 1 and the second electrode 2.

In the lithium half cells prepared above, the current collector 11 is a copper foil, the second electrode 2 is metallic lithium, the separator is a polypropylene membrane, and the electrolyte is an electrolyte solution containing LiPF₆. In addition, the electrode material layer 12 comprises the anode materials (LVO or graphite) and the binder (pectin or Fe-doped pectin).

### Comparative Embodiment

The lithium half cells of Comparative embodiment is similar to the lithium half cells of Embodiments, except that pectin or Fe-doped pectin is substituted with PVDF or CMC/SBR (with 2:1 weight ratio). Thus, in lithium half cells of Comparative embodiment, the electrode material layer 12 comprises the anode materials (LVO or graphite) and the binder (PVDF or CMC/SBR)

### Battery Regeneration

The lithium half cells with the electrode material layer comprising LVO-pectin were regenerated herein. The first electrode 1 (as the anode) shown in FIG. 1 was washed with DI water to detach the electrode material layer 12 from the current collector 11 (copper foil). The detached electrode material layer 12 was added into the critic acid solution, the LVO particles were dissolved and become an ion liquid, and the molar ratio between the LVO and citric acid was 1 to 2. The precipitated carbon black was removed. Finally, the solution was dried for one night then heated at 500° C. for 10 hours to obtain the regenerated LVO.

### Analysis

Cyclic voltammetry was performed at scan rate of 0.1 mV s⁻¹ at room temperature for the CR2032-type coin cells using a PARSTAT MC 200 electrochemistry workstation between 3 V and 0.01 V. The charge and discharge profiles were collected by galvanostatic cycling between 0.01 V and 3 V vs. Li⁺/Li, applying a constant current of 0.1 C rate at room temperature with a Think Power battery testing system. Electrochemical impedance spectroscopy (EIS) was performed by the same workstation for the CR2032-type coin cells using with an AC amplitude of 10 mV between 100 kHz and 0.01 Hz.

The distribution of relaxation times (DRT) and the distribution function of relaxation times (DFRT) were calculated by DRT tools on the Gaussian discretization method with a regularization parameter of 10⁻⁴ and FWHM of 0.5 and Impedance Spectroscopy Genetic Programming (ISGP) program respectively. In general, peaks are obtained at different frequency regime and each electrochemical phenomenon is classified by a peak. The area of each peak is calculated separately by the package and then multiplied by maximum (un-normalized) resistivity to find the corresponding resistance in DFRT. To find the effective resistance (R_{eff}) of each peak, the resistance is divided by the total area of the DFRT.

Spin polarized electronic property are calculated using density functional theory (DFT) as implemented in the Quantum Espresso package. The electron wavefunctions and charge density were represented by a plane-wave basis set using an energy cutoff of 100 Ry. The Brillouin zone was sampled by 5×5×5 Monkhorst-Pack k-mesh grid. To describe the energies of V 3d states, Hubbard corrections (U_{eff}=4 eV) were incorporated. The relaxed structures are shown in SI. Additionally, the Ab initio molecular dynamics (AIMD) simulations are carried out to evaluate the stability of the ground-state LVO at different finite temperatures. The simulations are carried out in symmetrized structure at different temperatures with the Nośe-Hoover thermostat for 20 ps with a time step of 1 fs.

For the IR measurements, an FTIR (Bomem, Canada) was used. The 2 mg of the sample was dissolved in 200 μl double distilled water (DD water), then subject to sonication to achieve uniform dispersed solution. After complete solubility, to prepare samples for IR observation, initially 40 μl of the solution was dropped onto silicon wafer used as sample holder. After it dried, 20 μl each time until total 2 mg of the sample was deposited on the silicon wafer. The Si wafer was then placed in the light path of the FTIR, each spectrum was obtained with 400 scans acquisition using 4 cm⁻¹ instrumental resolution and a deuterated triglycine sulfate (DTGS) detector.

### Results—LVO as Anode Material

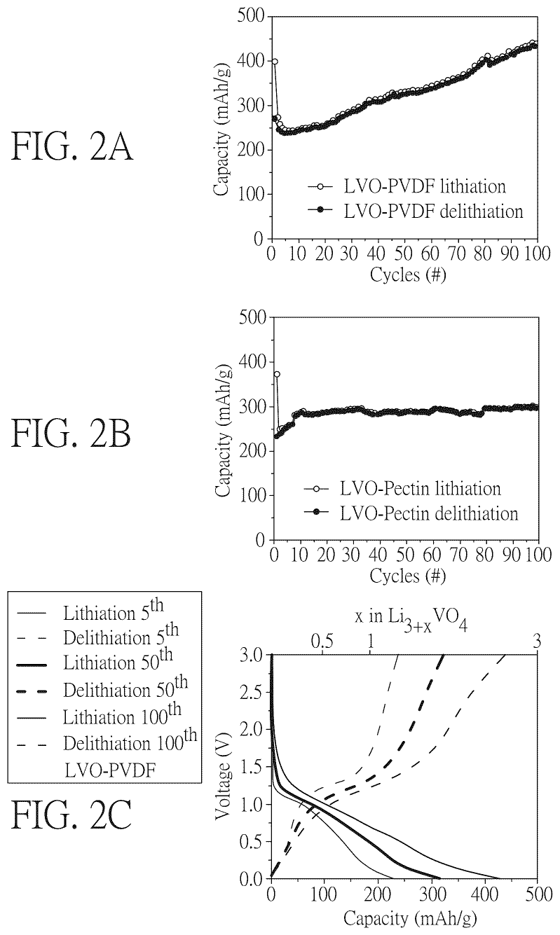

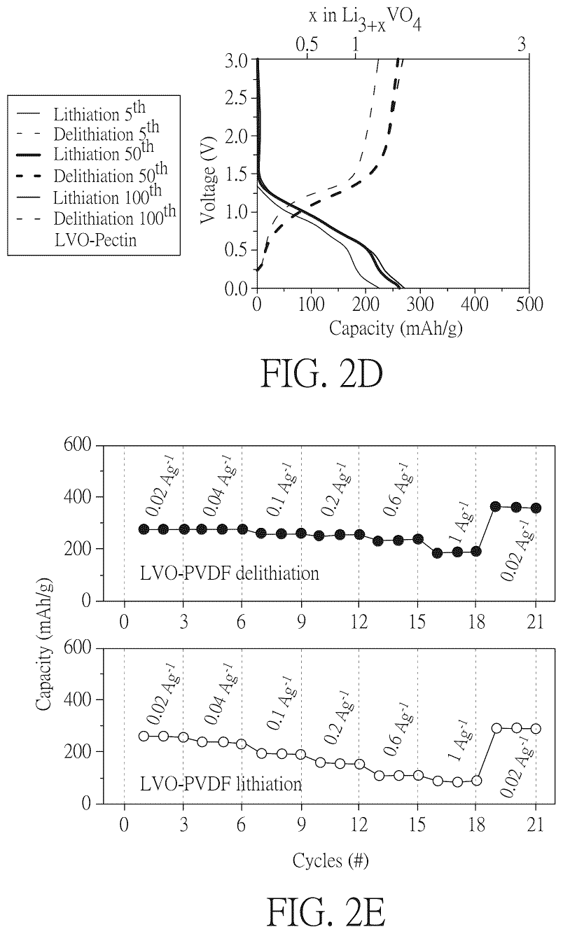

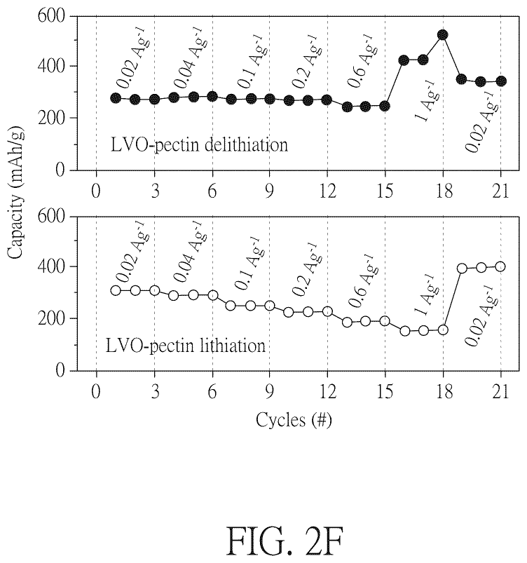

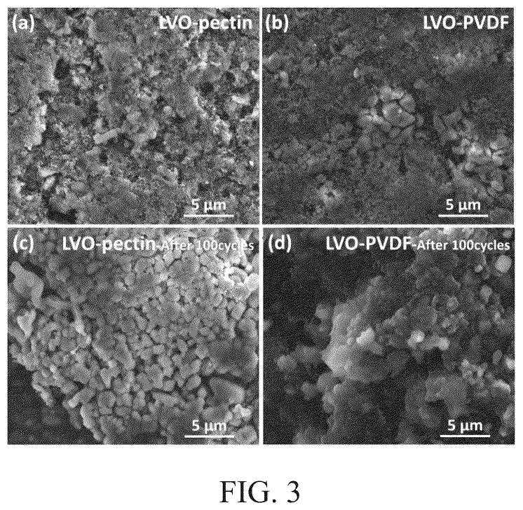

FIG. 2A to FIG. 2F are the results showing the life cycles and lithiation-delithiation profile of LVO electrode with different binders. FIG. 3 shows SEM images for LVO-pectin and LVO-PVDF electrodes before and after 100 cycles.

It is surprising that the capacity of LVO-PVDF increases from 230 mAh g⁻¹ at the first cycle to reach 430 mAh g⁻¹ as shown in FIG. 2A. In contrast, LVO-pectin electrode exhibits a stable capacity ˜260 mAh g⁻¹ as shown in FIG. 2B. While a high value initially, the capacity of LVO-PVDF starts to decrease after 220 cycles. On the other hand, LVO-pectin maintains stable specific capacity in prolonged cycles. SEM was used to observe the status of electrode for both LVO-pectin and LVO-PVDF before and after lithiation/delithiation processes. FIGS. 3(a) and (b) show the surface morphology of LVO-pectin and LVO-PVDF electrode before lithiation/delithiation process. After lithiation/delithiation process, the SEM images of the LVO-PVDF electrode (FIG. 3(d)) show that the LVO breaks into small particles after 100 cycles, but not in LVO-pectin electrode (FIG. 3(c)). This is likely due to the mechanical property difference between pectin and PVDF; where pectin has better elastic property than PVDF. Practically, a better elastic material is more beneficial to anodes, which may experience large volume changes during cycling. Therefore, pulverization exposing a fresh surface of active material to electrolyte would be minimized in the α-linked and COOH-functionalized pectin binder.

The XRD results of materials after 100 cycles show crystalline Li₃VO₄ phase in both samples (data not shown). All peaks in LVO-pectin electrode are well fitted with the reference pattern without any impurity and show better crystallinity than the LVO-PVDF electrode, whereas the XRD pattern of LVO-PVDF electrode contains peaks associated with LiOH. This result indicates that the pectin also potentially prevents unwanted reaction with lithium at the interface. Additionally, we have calculated the voltage profile theoretically and the results suggest that as Li-ion goes into the structure the voltage decreases and capacity increases, as shown in FIG. 2C and FIG. 2D. As shown in FIG. 2D, the lithiated structure after 100 charge/discharge cycles for LVO-pectin is Li_{4.5}VO₄, and is close to Li₆VO₄ for LVO-PVDF as noted in FIG. 2C. The LVO-PVDF undergoes a defragmentation which may cause the hiking in capacity.

The cell performance at different current density is shown in FIG. 2E and FIG. 2F. The delithiation characterization of half-cell was performed between 3 and 0.01 V vs. Li/Li⁺, and all lithiation current density was fix at 0.02 A g⁻¹, then change delithiation current density to 0.02 A g⁻¹, 0.04 A g⁻¹, 0.1 A g⁻¹, 0.2 A g⁻¹, 0.6 A g⁻¹ and 1 A g⁻¹, respectively. Both samples exhibit steady capacity retention up to current density of 0.2 A g⁻¹. A surprising feature of capacity increase is observed at delithiation with current density reaching 1 A g⁻¹ for LVO-pectin electrodes. However, this unusual capacity increase at high current density does not occur in LVO-PVDF anodes. To gain more complete picture, we also measured the electrochemical performance of lithiation under different current density for LVO-pectin electrode and LVO-PVDF electrode. However, the results all appear normal as also shown in FIG. 2E and FIG. 2F.

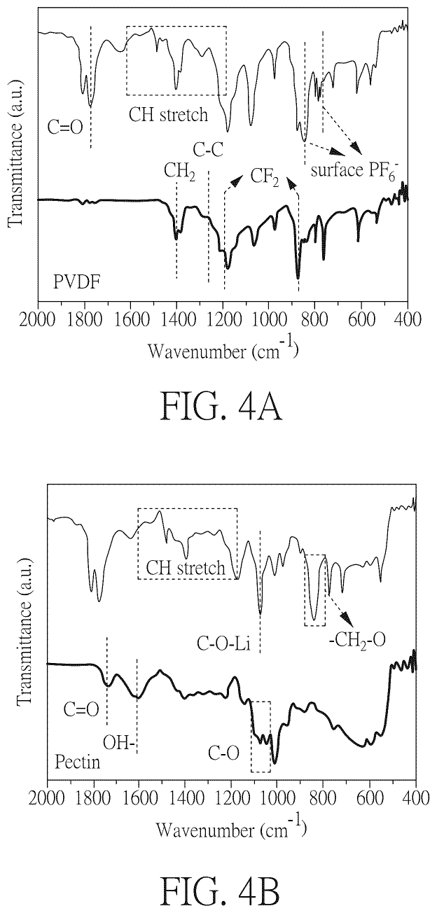

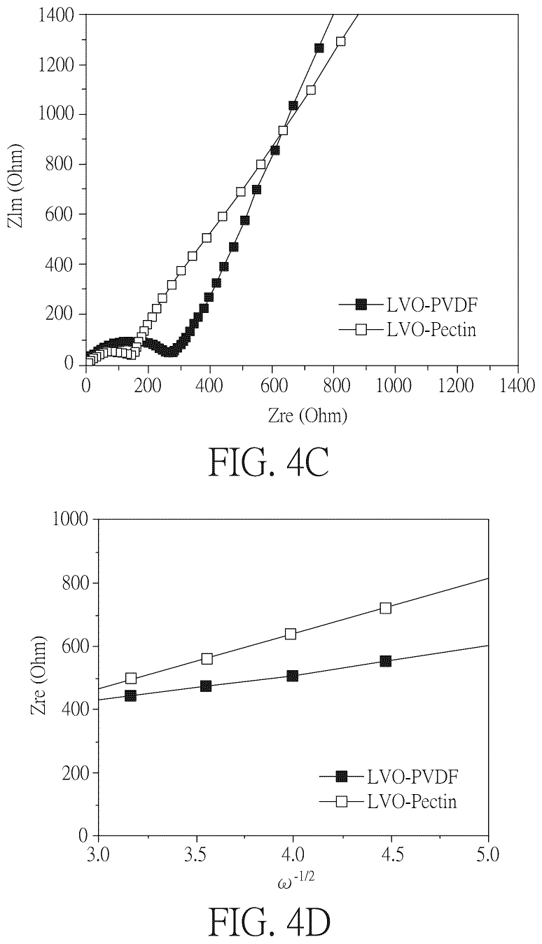

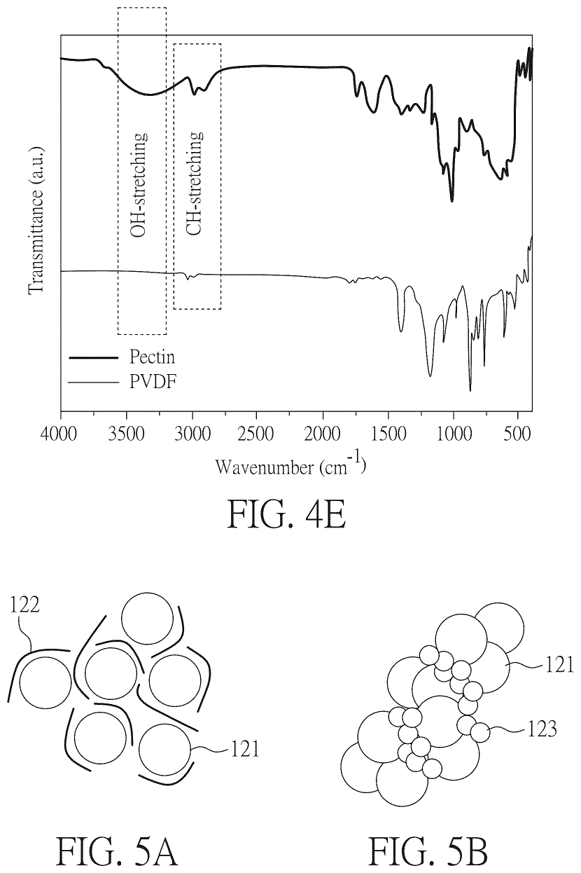

The detail of the surface film formed as a result of the chemical reaction between LVO-pectin electrode and electrolyte were revealed by Fourier transform infrared spectra (FTIR) measurement. FIG. 4B indicates that the C—O bond of LVO-pectin electrode reacts with the electrolyte and formed C—O—Li bond from Li-salt and —CH₂—O bond from diethylcarbonate after soaking in electrolyte for 12 h. Those chemical bonds of the pectin can act as the nucleophilic or electrophilic sites to form conducting filaments and lead to lower resistance of pectin. On the contrary, the observed ligands do not exist in the LVO-PVDF electrode, there appears only a strong peak at 840 cm⁻¹ from the v_{P-F} stretching mode associated with PF₆⁻ in the FTIR spectrum as shown in FIG. 4A, which is normally absorbed on the surface of PVDF based electrode. Furthermore, an interfacial surface charge between the active material and pectin induced interfacial polarization results a charge redistribution that contributes to the capacity during the charge process. Since the LVO-pectin exhibits excellent rate performance, we further examined its long-cycle behavior under current density of 0.2 A g⁻¹. The result shows the capacity continues to increase with cycles and finally stable at 570 mAh g⁻¹, which is very close to the theoretical capacity of three Li ion interaction.

Electrochemical impedance spectroscopy (EIS) was conducted from 100 kHz to 0.1 Hz at open circuit voltage to gain more insights into the interfacial property between the electrode and electrolyte as shown in FIG. 4C and FIG. 4D. FIG. 4C shows the Nyquist plots of LVO-pectin electrode and LVO-PVDF electrode, both present a compressed semicircle in the high frequency region and an inclined line in the low frequency region. These results indicate that the electrochemical process is determined by charge transfer in the electrode/electrolyte interface and Li⁺ ion diffusion. At OCV state, a smaller semicircle in the high frequency region is obviously observed on LVO-pectin electrode than that of LVO-PVDF electrode, manifesting its greatly lowered charge-transfer resistance. Interestingly, the linear fitting of Z′ vs. ω^{-1/2} curves in FIG. 4D indicates that the LVO-PVDF electrode exhibits a lower slope, suggesting enhanced Li-ion mobility. This result can be attributed to the different surface morphology of LVO-pectin electrode and LVO-PVDF electrode.

FIG. 5A and FIG. 5B are perspective views showing the interfacial formation scenarios of LVO-pectin and LVO-PVDF. For LVO-pectin coating, there is a strong interaction between side chains of hydroxyl groups and the LVO surface. Carboxyl groups of pectin can form chemical bonds with surface hydroxyl groups of LVO particles. Therefore, the pectin binder 122 smoothly covered on the surface of the LVO particles 121 and act as a shield, as shown in FIG. 5A. On the other hand, only weaker hydrogen-bond-based interactions are possible between hydroxyl groups of PVDF and the LVO surface. Therefore, the LVO particles 121 connected to the PVDF binder 123 without much protection. FTIR results further provide evidence to confirm the ligands binding onto coating surface, as shown in FIG. 4E. The characteristic C—H bond stretching and the OH bond stretching were strongly detected from pectin binder in the range from 3000 to 2800 cm⁻¹ and 3000 and 3800 cm⁻¹, respectively.

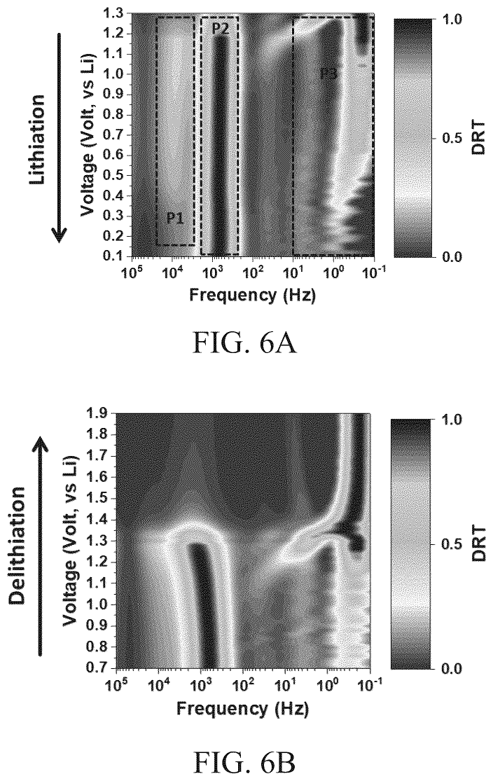

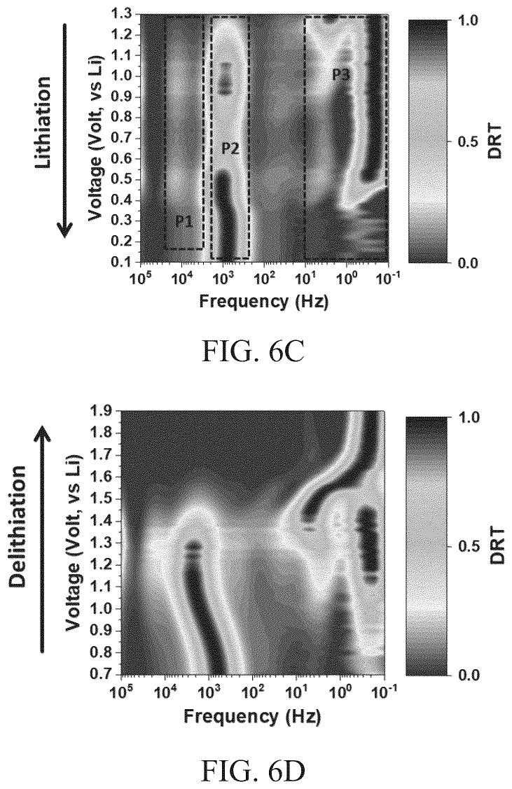

The impedance responses have been modelled by computing the distribution of relaxation times (DRT). The DRT derived from all the impedance data (data not shown) were mapped out in greater detail in 2D as the plots in FIG. 6A to FIG. 6D. For these plots, the impedance data were collected across the entire voltage range in 20 mV increments. There are three signatures at around frequency region of 10⁴ Hz (P1), 10³ Hz (P2) and 100 Hz (P3), respectively. P1 corresponds to surface film resistance as originated from Li ion migration through the electrode surfaces, P2 to electrode/electrolyte interfacial charge transfer resistances, and P3 to active material/current collector interfacial charge transfer and solid diffusion, respectively. Comparing the plots of both samples, it is clear that the signature P1 in LVO-PVDF (as shown in FIG. 6A) is much brighter than LVO-pectin (as shown in FIG. 6C), indicating that the resistance of surface film is higher in LVO-PVDF electrode. The results show that the signature P2 is continuous in LVO-PVDF during lithiation (as shown in FIG. 6A), but not in LVO-pectin (as shown in FIG. 6C). This observation gives additional support to the shielding role of pectin binder on the LVO surface. A similar result is also observed in signature P3 for LVO-pectin during lithiation (as shown in FIG. 6C). For delithiation, Li ion diffused firstly from LVO particle to the pectin binder, then back to the electrolyte from pectin binder. The above detailed analysis indicates that there are two domains in the LVO-pectin electrode, and this observation provides evidence to explain the excellent electrochemical behavior observed in LVO-pectin electrode.

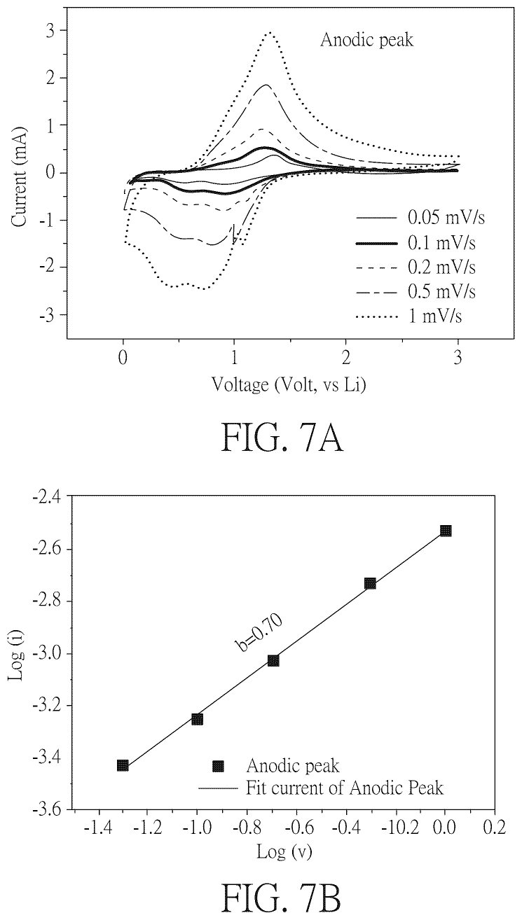

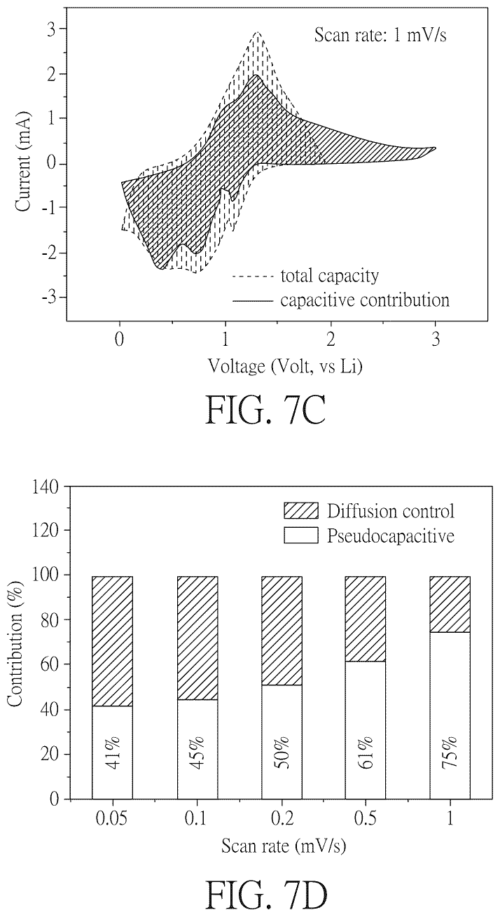

FIG. 7A displays the CV plots, and FIG. 7B is the plot in log scale using the Randles-Sevcik relation iₚ=av^{b} at different potential scan rates. The result gives the exponent b˜0.70 at 1.3V, suggesting capacitive contributions present in the LVO-pectin cell, which provides the mechanism for higher capacity under high current density. On the other hand, the estimated exponent b is ˜0.58 for LVO-PVDF cell (data not shown), indicating Li-ion diffusion is dominant. We have also performed the impedance measurements under different current density (data not shown). The charge-transfer resistance of LVO-pectin becomes lower at high current density (0.6 A g⁻¹, 1 A g⁻¹), which is consistent with rate performance. We also estimated the calculated capacitance (C_{cal}). The results show that the LVO-pectin exhibits the highest C_{cal} value of 4.48 μF at current density of 1 A g⁻¹, which are consistent with the CV data. Further analysis of the relative contributions from diffusion and capacitance are shown in FIG. 7C and FIG. 7D. The capacitive contribution increases with increasing scan rate and reaches 75% at 1 mV s⁻¹ rate.

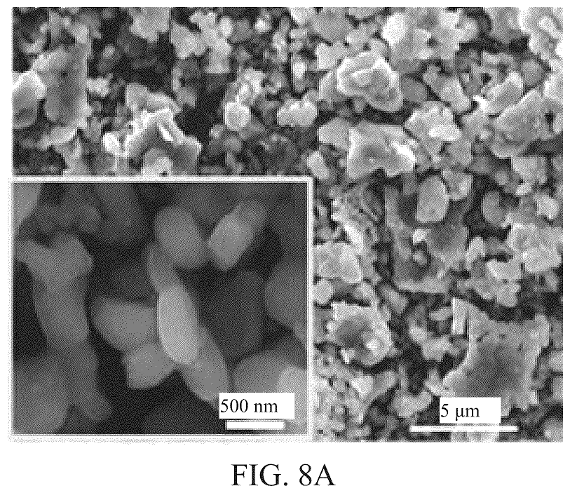

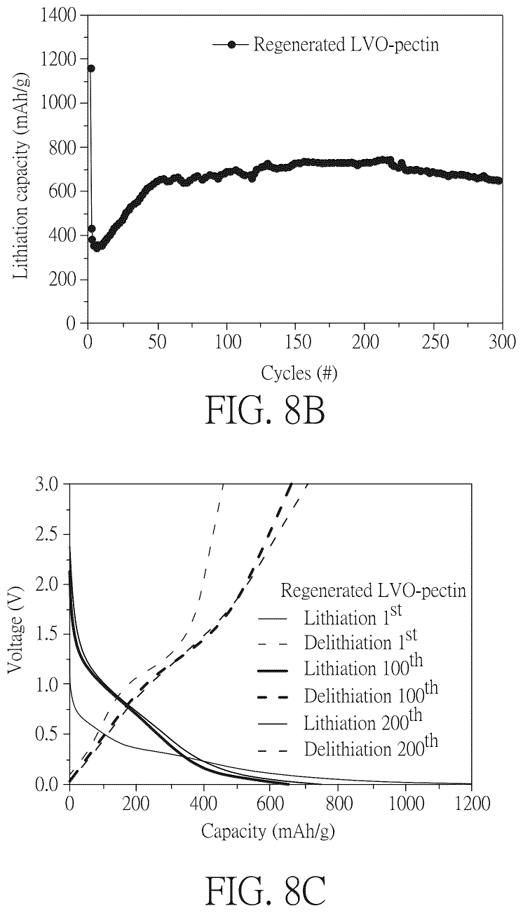

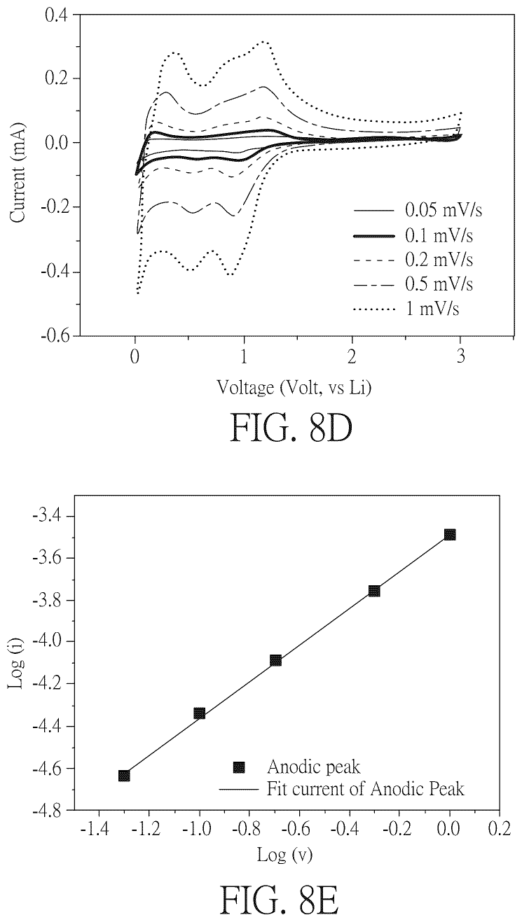

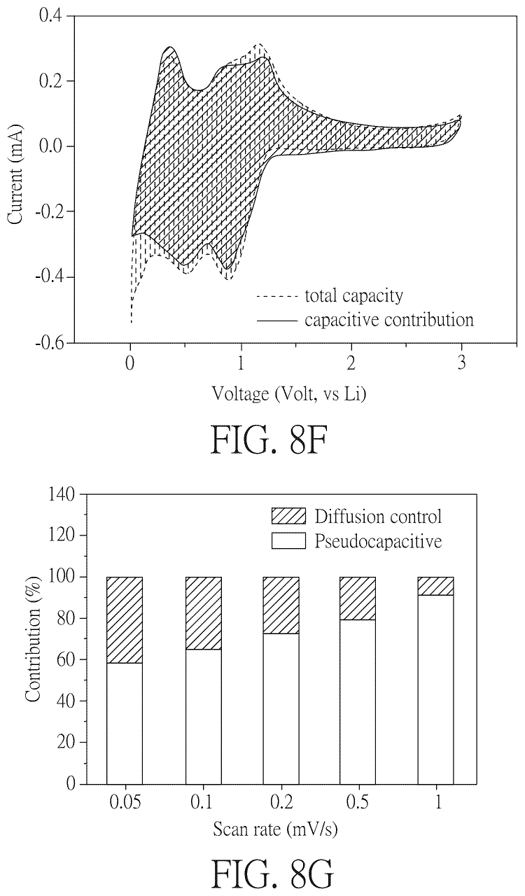

The benefit of using pectin as binder is a result of its chain structure, which binds active material while allowing ion species diffusion. In addition, pectin does not contain fluorine and can be dissolved easily. The spent LVO-pectin cell can be regenerated using environmental friendly processes. In the present invention, we simply rinsed the spent cell with deionized water to recover the LVO compound that disengaged from underlying foil. The use of citric acid in the regeneration process helps maintain the LVO structure intact as evident from X-ray diffraction pattern and SEM images. Even not shown in the figure, the XRD pattern of the dried recovered material shows the same orthorhombic phase as the pristine compound with minor impurity phase, indicating nearly 90% material recovery. Meanwhile, the regenerated LVO particles are refined into sub-micron sizes, allowing excess surface to participate in the reaction, as shown in FIG. 8A.

We then investigated the detailed electrochemical performance of the half-cell using the regenerated LVO with the pectin binder. The results of FIG. 8B demonstrates that the active regenerated LVO material can be lithiated with nearly the same capacity as the cell with pristine material with an initial capacity of ˜300 mAh g⁻¹. The cell capacity continues to increase to reach a stable value of ˜700 mAh g⁻¹ until about 220 cycles at current density of 0.2 A g⁻¹, then gradually decreases to close to the theoretical capacity at 300 cycles. From the voltage-capacity profile as shown in FIG. 8C, the coulomb efficiency of the first cycle is low as the regenerated nanoparticles consume massive Li ions for SEI formation. However, the coulomb efficiency resumes to almost 100% after 2^{nd} cycle.

We also made the analysis on the regenerated LVO cells and found that the pseudocapacitive effect is significantly enhanced when materials are nanosized. The results of pseudocapacitive effect are shown in FIG. 8D to FIG. 8G. The exponent b extracted is ˜0.88, indicating the capacitive effect become more dominant. Indeed, the percentage of capacitive contribution to the total capacity reaches ˜91% at 1 mV s⁻¹ scan rate for the regenerated cell. Our results clearly demonstrate that LVO-pectin anode can be regenerated with 100% capability for subsequent lithiation.

In one embodiment of the present invention, pectin polymers are used as binders with Li₃VO₄ anodes in lithium-ion battery. The LVO-pectin cell shows a stable capacity and long lifespan. Enhanced charging specific capacity at high current density is observed in LVO-pectin cells, but not in cells with LVO-PVDF electrode, demonstrating a surface resistance switching capability from pectin. The results show the capacity continuously increase with cycles and finally stable at 570 mAh g⁻¹ under current density of 0.2 A g⁻¹, which is very close to the theoretical capacity of three Li ion interaction. Detailed EIS with DRT analysis and CV scan at different sweep rates confirm that the pseudocapacitive effect becomes dominant for Li-storage in the LVO-pectin electrode. The half-cell can be regenerated with nearly 90% material recovery and 100% capability for subsequent lithiation. Our results unambiguously demonstrated that the electrode combining pectin binder with transition metal oxides, such as LVO, provides the opportunity for developing environmentally friendly recycle processes; on the other hand, it could lead to the development of material for Li-ion battery that achieves both high energy and high-power density.

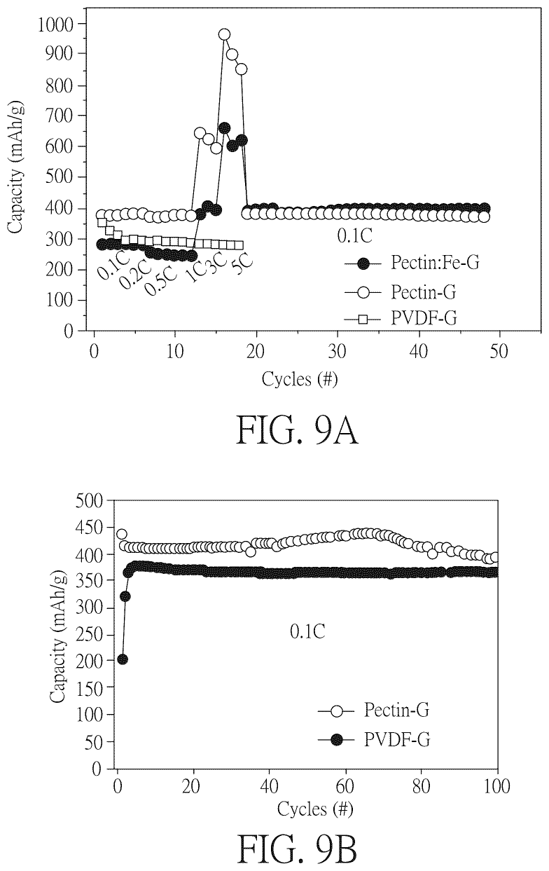

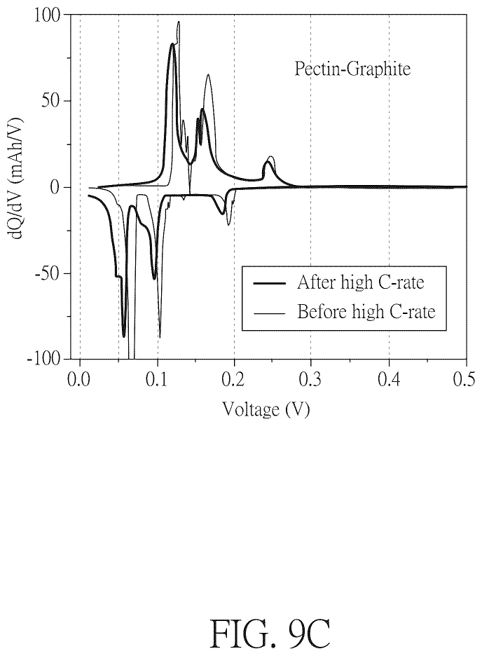

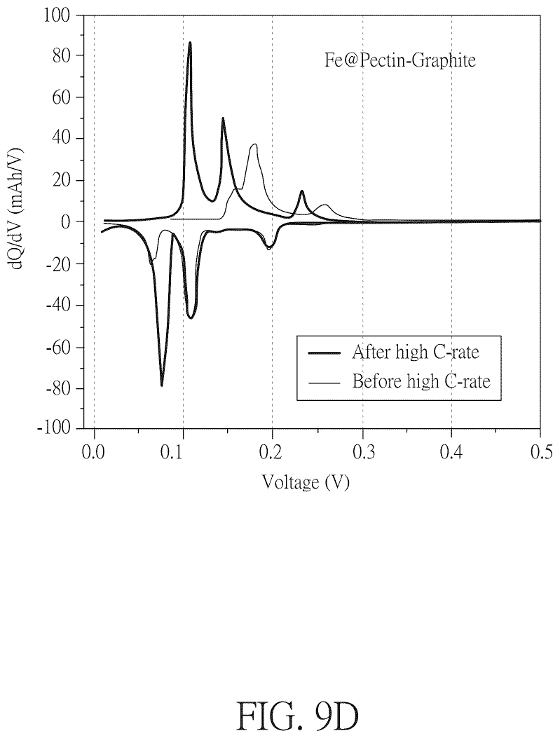

FIG. 9A and FIG. 9B display the cycling performance of graphite with PVDF, pectin and pectin:Fe binder, including capacity at different C-rate. The capacity maintains stable up to 100 cycles for both pectin-graphite and PVDF-graphite, as shown in FIG. 9B, indicating the good stability of the pectin material.

Specific capacity for PVDF-graphite anode is stable at 360 mAh g⁻¹. However, this value is much lower than the maximum value of 435 mAh g⁻¹ observed for pectic-graphite, as shown in FIG. 9B. Though the specific capacity of pectin-graphite decreases after reaching maximum at 68 cycles, its value maintains around 400 mAh g⁻¹ at long cycle, which is higher than that of PVDF-graphite, consistent with expectation that pectin has better elastic property than PVDF. A large elastic property is more beneficial to anodes experiencing large volume changes during cycling. Therefore, the reason behind the capacity increment can be attributed to the high strain resistance in pectin as well as strong affinity to bonding with the active material surface, leading to remarkable cycling performance of the graphite electrode. In sum, good binding property can efficiently enhance lithium-ion transport.

The effect of the binders is examined at different charge/second C-rates (0.1 to 5 C) as shown in FIG. 9A. The C-rate characterization of half-cell was performed between 3 and 0.01 V versus Li/Li⁺, and all lithiation was performed at 0.1 C, then delithiation changed at 0.1, 0.2, 0.5, 1, 3, and 5 C. For the pectin-based electrode, a steady capacity retention is observed up to 1 C indicating the applicability of pectin as binder. Interestingly, capacity increases dramatically at high rate of 3 C in pectin-based electrodes. Conversely, the C-rate for PVDF-graphite is conventional, decreasing with increasing C-rate.

Similar anomalous C-rate performance with a presumed capacity switching at 3 C is also observed in pectin:Fe binder for graphite anode. However, the initial specific charging capacity in pectin:Fe binder is lower in value in comparison with the pristine pectin binder at 0.1 C. When the measurement resets to 0.1 C after high C-rate measurements, the capacity increases to a value larger than for the pristine pectin and remains the same value to longer cycles. This suggests addition of Fe to pectin indeed enhances the charge storage capability, and supports the observed Fe³⁺-state by magnetization measurement. The relatively low capacity at low initial C-rate in pectin:Fe can also be understood based on the dQ/dV analysis, shown in FIG. 9C and FIG. 9D for pectin and pectin:Fe, respectively. The data suggest for pectin:Fe the graphite does not contribute much to capacity initially at low C-rate before switching at 3 C.

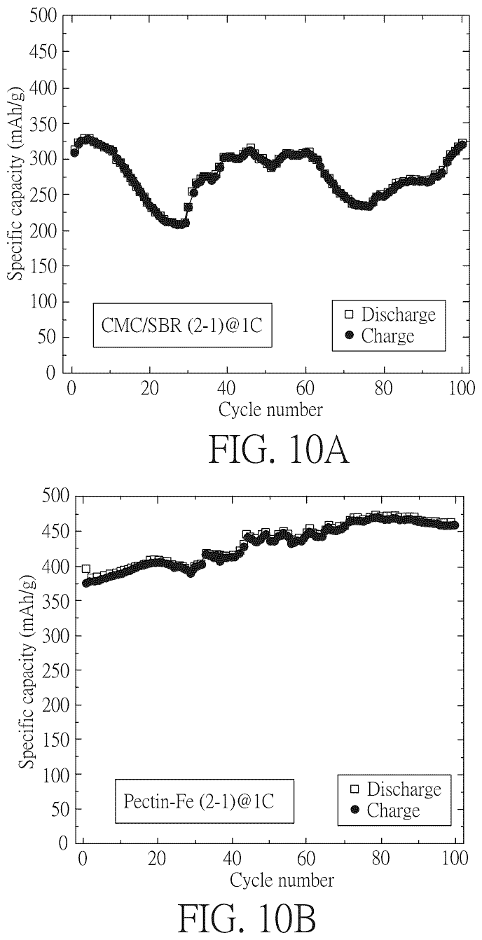

We have also tested the binder performance of CMC/SBR in comparison to Fe-pectin. The results are shown FIG. 10A and FIG. 10B, where FIG. 10A displays the specific capacity of graphite using CMC/SBR (with 2:1 ratio) as binder under 1 C rate up to 100 cycles; and FIG. 10B is that using Fe-pectin binder. The specific capacity using CMC/SBR as binder fluctuates between 350 and 200 mAh g⁻¹. On the other hand, the capacity of graphite using Fe-pectin as binder under 1 C rate shows an initial capacity about 350 mAh g⁻¹ and gradually increases to a stable value close to 450 mAh g⁻¹ at 100 cycles. It is noted that the theoretical specific capacity of natural graphite is 372 mAh g⁻¹. The result of close to 450 mAh g⁻¹, which is higher than the theoretical value for graphite, in the cell using Fe-pectin as binder is surprising. This observation suggests that the Fe-pectin may play the role to allow more Li-ion to be interacted in the active material.

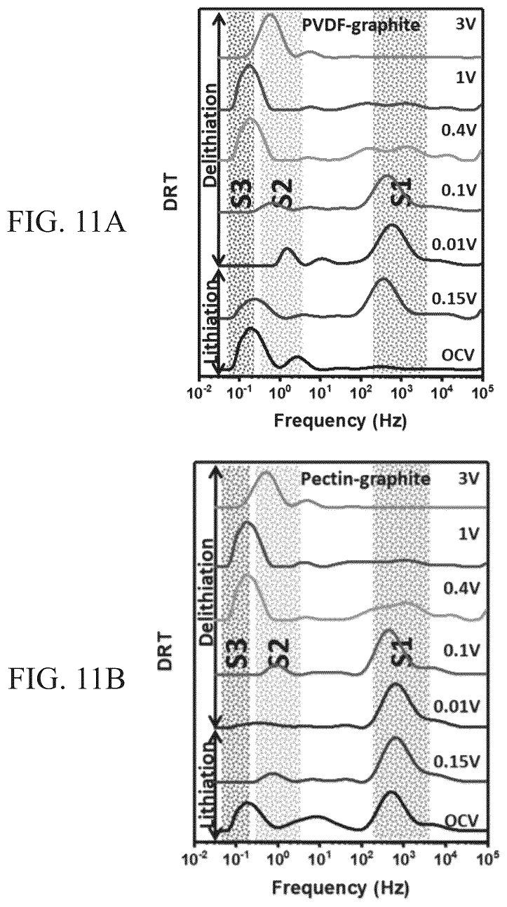

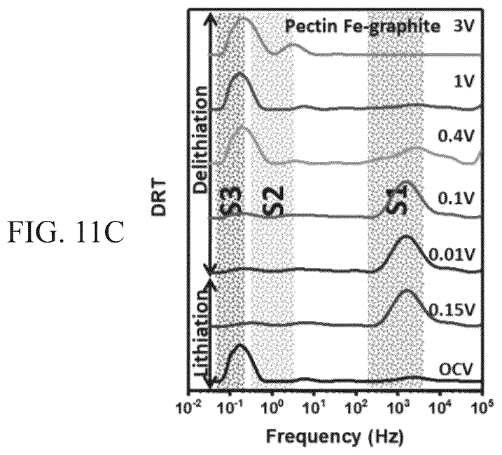

Electrochemical impedance spectroscopy (EIS) coupled with the distribution of relaxation times is employed to study the ion transport for all the samples at both lithiation and delithiation conditions. The whole distribution of relaxation times (DRTs) contain three main peaks around 1.6 kHz, 3.2 Hz and 0.2 Hz, (FIG. 11A to FIG. 11C) starting from right to left. The DRTs are found from EIS measurement. The positions of peaks S1, S2, and S3 correspond to surface film resistance as obtained due to Li-ion migration through electrode surface, and electrode/electrolyte interfacial charge transfer resistances, respectively.

The analysis confirms the lithiation process is binder induced. The surface film effect, which occurs at OCV in pectin-graphite only, maintains a contribution till the delithiated voltage of 0.1 V. In contrast, the interfacial charge transfer effect is not observed at the lithiated and delithiated voltages of 0.01 and 0.1 V, respectively. Peak S3 is related to lithiation/delithiation of graphite and binder. More specifically, the lithiation process invokes charge transfer process across the graphite/electrolyte interface but the additive property of binder helps such interfacial process.

The high-capacity behavior for pectin related samples can be considered as diffusion-controlled intercalation processes (DIP) or surface-induced capacitive processes (SCP). For DIP, the current is linearly proportional to the square root of the voltage (V) whereas for SCP current is proportional to voltage. As the current is accumulation of total charge (Q) over time; the Q (in FIG. 9C and FIG. 9D) is a summation of Q_{d} and Qₛ as obtained from DIP and SCP, respectively. Both the lithiation (1.5 to 0.1 V) and delithiation processes (0.4 to 1.5 V) are ascribed as DIP assisted for pectin:Fe-graphite, unlike PVDF-graphite and pectin-graphite samples where SCP is noted. Thus, the high capacity in pectin-Fe is possibly from dominating DIP effect. The capacitance from Peak S1 for all the samples is calculated in order to determine the SCP quantitatively. Peak S1 shifts towards low frequency side for both graphite-pectin and PVDF-graphite samples but not in pectin:Fe-graphite suggesting ionic motion is transition metal dependent. During lithiation and initial delithiation (up to 0.1 V) the peak S1 possesses lowest capacitances (˜1 μF) for pectin-Fe, unlike graphite-PVDF and pectin-graphite. Overall, due to this dominating DIP and low capacitances, pectin:Fe shows highest capacity among three samples. Highest columbic efficiency for pectin:Fe is observed (data not shown), which could be due to highest number Li-ion transference per formula unit in a single charge discharge cycle. Overall, we can confirm that the presence of Fe facilitates the charge transfer process and the electronic conductivity.

In order to assess the potential of pectin polymers for use in lithium-ion battery electrodes, we have characterized the detailed properties of Fe-doped pectin films (data not shown). These results suggest that the interface between pectin and active materials may provide additional channel for charge storage. This is consistent with the suggestion that the material could exhibit better charge holding capacity and is suitable for supercapacitor application. These observations suggest one might be able to achieve, using the pectin-based materials, battery with both high energy and high-power density.

Although the present invention has been explained in relation to its embodiment, it is to be understood that many other possible modifications and variations can be made without departing from the spirit and scope of the invention as hereinafter claimed.

1. An electrode for a lithium-ion battery, comprising:
a current collector; and
an electrode material layer disposed on the current collector, wherein the electrode material layer comprises an anode material and a binder, the binder is pectin, its derivative or a combination thereof, and the anode material is selected from the group consisting of lithium vanadium oxide, lithium titanium oxide, lithium iron oxide, graphite, and a combination thereof.

2. The electrode of claim 1, wherein the binder is pectin.

3. The electrode of claim 1, wherein the binder is Fe-doped pectin.

4. The electrode of claim 3, wherein a weight ratio of pectin to iron in the Fe-doped pectin ranges from 1:1 to 10:1.

5. The electrode of claim 1, wherein an amount of the binder ranges from 3 wt % to 10 wt % based on a total weight of the electrode material layer.

6. The electrode of claim 1, wherein the anode material is lithium vanadium oxide.

7. The electrode of claim 1, wherein the anode material is graphite.

8. The electrode of claim 1, wherein the electrode material layer further comprises a conductive additive.

9. The electrode of claim 8, wherein an amount of the conductive additive ranges from 1 wt % to 10 wt % based on a total weight of the electrode material layer.

10. A lithium-ion battery, comprising:
a first electrode, comprising:
a current collector; and
an electrode material layer disposed on the current collector, wherein the electrode material layer comprises an anode material and a binder, the binder is pectin, its derivative or a combination thereof, and the anode material is selected from the group consisting of lithium vanadium oxide, lithium titanium oxide, lithium iron oxide, graphite, and a combination thereof.
a second electrode opposite to the first electrode;
a separator disposed between the first electrode and the second electrode; and
an electrolyte disposed between the first electrode and the second electrode.

11. The lithium-ion battery of claim 10, wherein the binder is pectin.

12. The lithium-ion battery of claim 10, wherein the binder is Fe-doped pectin.

13. The lithium-ion battery of claim 12, wherein a weight ratio of pectin to iron in the Fe-doped pectin ranges from 1:1 to 10:1.

14. The lithium-ion battery of claim 10, wherein an amount of the binder ranges from 3 wt % to 10 wt % based on a total weight of the electrode material layer.

15. The lithium-ion battery of claim 10, wherein the anode material is lithium vanadium oxide.

16. The lithium-ion battery of claim 10, wherein the anode material is graphite.

17. The lithium-ion battery of claim 10, wherein the electrode material layer further comprises a conductive additive.

18. The lithium-ion battery of claim 17, wherein an amount of the conductive additive ranges from 1 wt % to 10 wt % based on a total weight of the electrode material layer.
